(19) United States
(12) Patent Application Publication
(10) Pub. No.: US 2024/0183935 A1
(43) Pub. Date: Jun. 6, 2024

(54) JOINT FMCW SENSING AND OFDM COMMUNICATIONS

(71) Applicant: QUALCOMM Incorporated, San Diego, CA (US)

(72) Inventors: Danlu ZHANG, San Diego, CA (US); Weimin DUAN, San Diego, CA (US); Jing JIANG, San Diego, CA (US); Roberto RIMINI, San Diego, CA (US); John Edward SMEE, San Diego, CA (US); Peter Pui Lok ANG, San Diego, CA (US); Lai Kan LEUNG, Carlsbad, CA (US); Seyedkianoush HOSSEINI, San Diego, CA (US)

(21) Appl. No.: 18/061,967

(22) Filed: Dec. 5, 2022

(51) Int. Cl. G01S 7/00; G01S 7/35; G01S 13/86; H04L 5/00

(52) U.S. Cl. CPC G01S 7/006; G01S 7/35; G01S 13/86; H04L 5/0007

(57) ABSTRACT

Aspects presented herein may enable a wireless device (e.g., a joint FMCW radar and communication system) to transmit and/or receive an FMCW signal and an OFDM signal using the same time and frequency resources. In one aspect, a first wireless device receives an indication of a scheduled transmission for an FMCW waveform via a set of time-frequency resources. The first wireless device transmits or receives the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform.

### TECHNICAL FIELD

The present disclosure relates generally to communication systems, and more particularly, to a wireless communication involving radio frequency (RF) sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives an indication of a scheduled transmission for a frequency-modulated continuous-wave (FMCW) waveform via a set of time-frequency resources. The apparatus transmits or receives the FMCW waveform via the set of time-frequency resources based on the indication, where the FMCW waveform is separated from an orthogonal frequency-division multiplexing (OFDM) waveform by a buffer zone including a first gap in frequency, where the first gap in frequency is based on an interference level between the FMCW waveform and the OFDM waveform.

In an aspect of the disclosure, a method, a computer-readable medium, and an apparatus are provided. The apparatus schedules a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform. The apparatus transmits an indication of the scheduled transmission for the FMCW waveform and the OFDM waveform via the set of time-frequency resources.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of radar signals (e.g., radar reference signals (RRSs)) generated from a wireless device in accordance with various aspects of the present disclosure.

FIG. 6 is a diagram illustrating an example of radar waveforms in accordance with various aspects of the present disclosure.

FIG. 7 is a diagram illustrating an example architecture of a frequency-modulated continuous-wave (FMCW) radar in accordance with various aspects of the present disclosure.

FIG. 8 is a communication flow illustrating an example of configuring at least one wireless device to transmit/receive a FMCW signal and/or an orthogonal frequency-division multiplexing (OFDM) signal via a same set of time and frequency resources based on a resource allocation that keeps a buffer zone between the FMCW signal and the OFDM signal to reduce interference between the two signals according to various aspects of the present disclosure.

FIG. 8 is a diagram illustrating an example of transmitting/receiving an FMCW waveform and an OFDM waveform via same time-frequency resources in accordance with various aspects of the present disclosure.

FIG. 9 is a diagram illustrating an example of transmitting/receiving an FMCW waveform and an OFDM waveform via same time-frequency resources in accordance with various aspects of the present disclosure.

FIG. 10 is a diagram illustrating an example of transmitting/receiving an FMCW waveform and an OFDM waveform via same time-frequency resources in accordance with various aspects of the present disclosure.

FIG. 11 is a diagram illustrating an example of transmitting/receiving an FMCW waveform and an OFDM waveform via same time-frequency resources in accordance with various aspects of the present disclosure.

FIG. 12 is a diagram illustrating an example of transmitting/receiving an FMCW waveform and an OFDM waveform via same time-frequency resources in accordance with various aspects of the present disclosure.

FIG. 13 is a diagram illustrating an example of transmitting/receiving an FMCW waveform and an OFDM waveform via same time-frequency resources in accordance with various aspects of the present disclosure.

FIG. 14 is a diagram illustrating an example of transmitting/receiving an FMCW waveform and an OFDM waveform via same time-frequency resources in accordance with various aspects of the present disclosure.

FIG. 15 is a diagram illustrating an example of a digital FMCW waveform in accordance with various aspects of the present disclosure.

FIG. 16 is a flowchart of a method of wireless communication.

FIG. 17 is a diagram illustrating an example of a hardware implementation for an apparatus.

FIG. 18 is a diagram illustrating an example of a hardware implementation for a network entity.

FIG. 19 is a flowchart of a method of wireless communication.

FIG. 20 is a diagram illustrating an example of a hardware implementation for a network entity.

### DETAILED DESCRIPTION

Aspects presented herein may enable a joint communication-radar (JCR) (e.g., a joint FMCW radar and communication system) to transmit and/or receive a frequency-modulated continuous-wave (FMCW) signal and an orthogonal frequency-division multiplexing (OFDM) signal using the same time and frequency resources (e.g., the signals are transmitted/received simultaneously using a same frequency band by one or more entities). Aspects presented herein may enable the interference between a FMCW signal and an OFDM signal to be manageable by keeping a frequency buffer zone around the FMCW signal when two signals are transmitted using same time and frequency resources. Aspects presented herein may also provide parameters and scheduling mechanisms for the frequency buffer zone and hopping schemes associated with digital FMCW waveforms, such that a joint sensing and communication system with a relatively low complexity and power consumption is provided.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

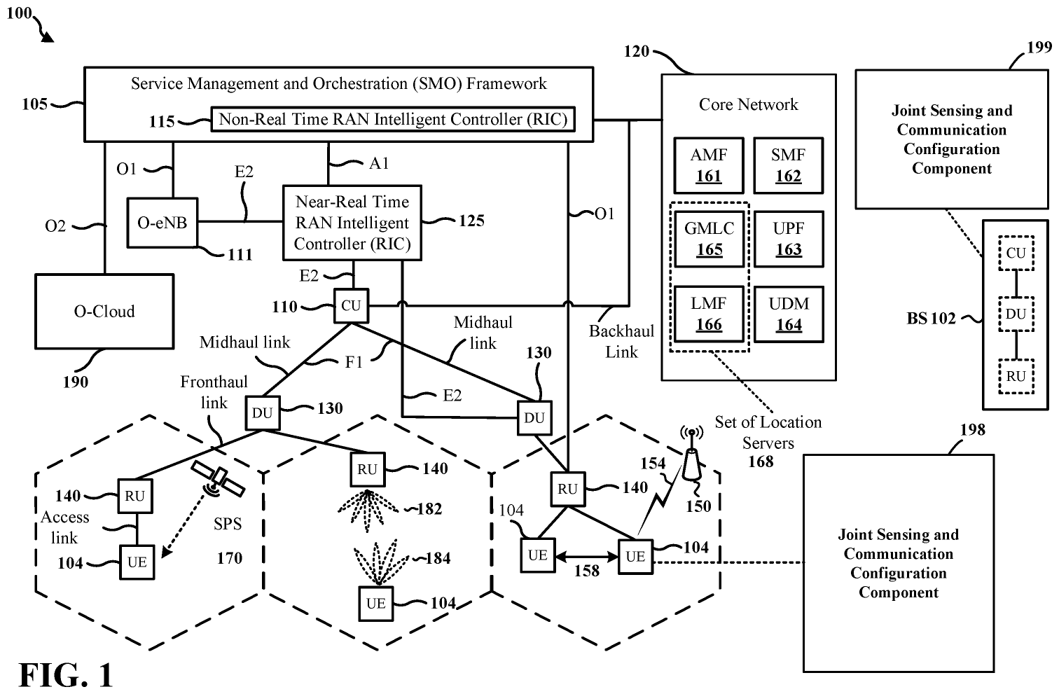

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RA configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may be configured to receive an indication of a scheduled transmission for an FMCW waveform via a set of time-frequency resources; and transmit or receive the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform (e.g., via the joint sensing and communication configuration component 198).

In certain aspects, the base station 102 may be configured to schedule a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform; and transmit an indication of the scheduled transmission for the FMCW waveform and the OFDM waveform via the set of time-frequency resources (e.g., via the joint sensing and communication configuration component 199).

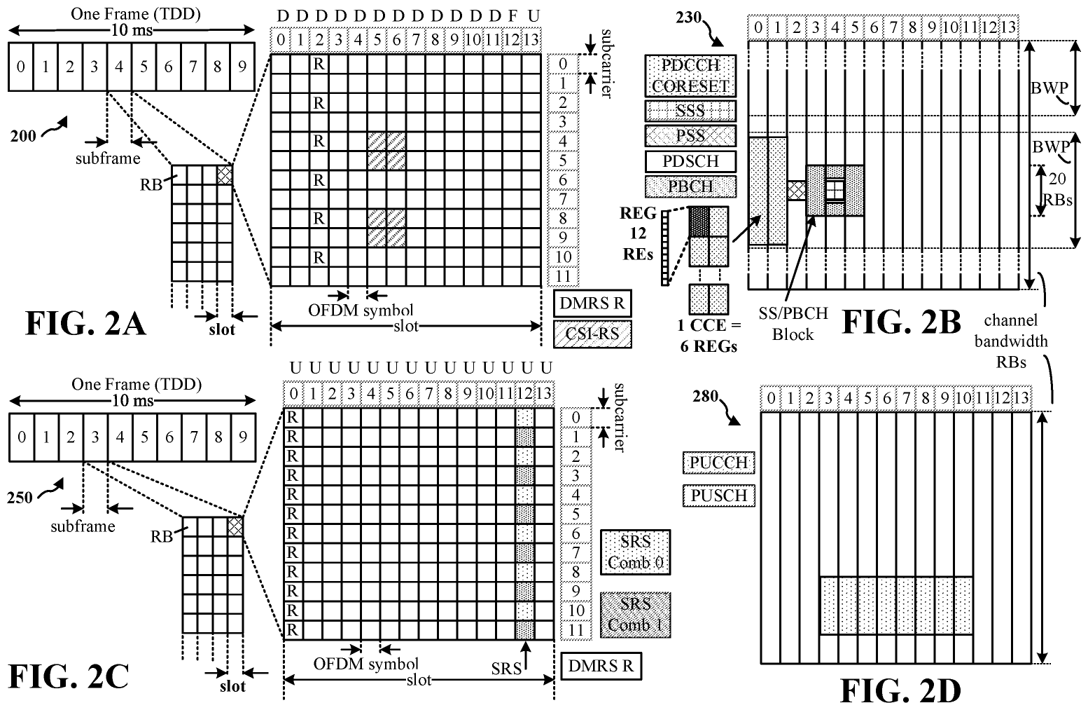

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

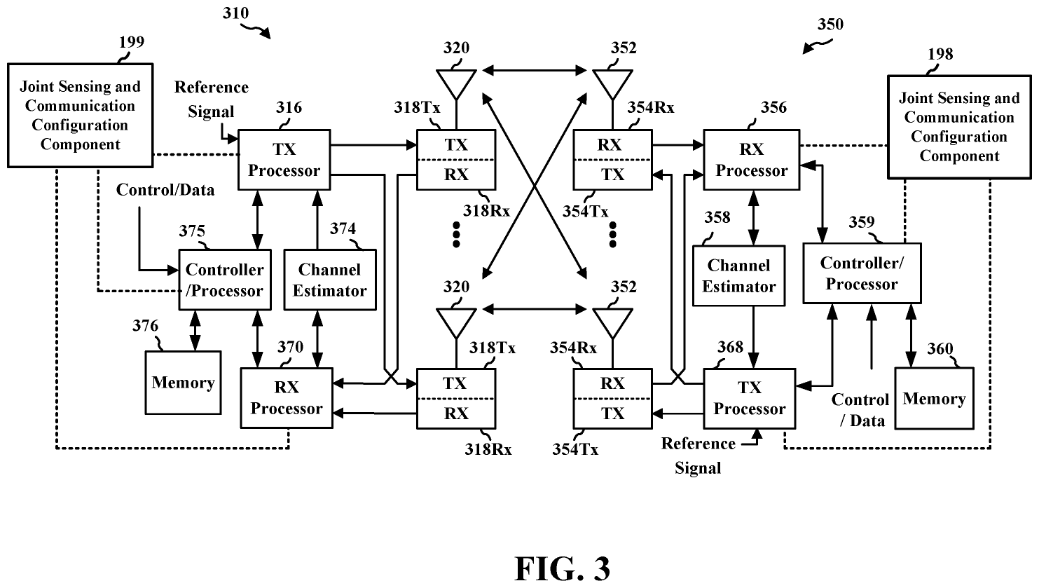

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the joint sensing and communication configuration component 198 of FIG. 1.

At least one of the TX processor 316, the RX processor 370, and the controller/processor 375 may be configured to perform aspects in connection with the joint sensing and communication configuration component 199 of FIG. 1

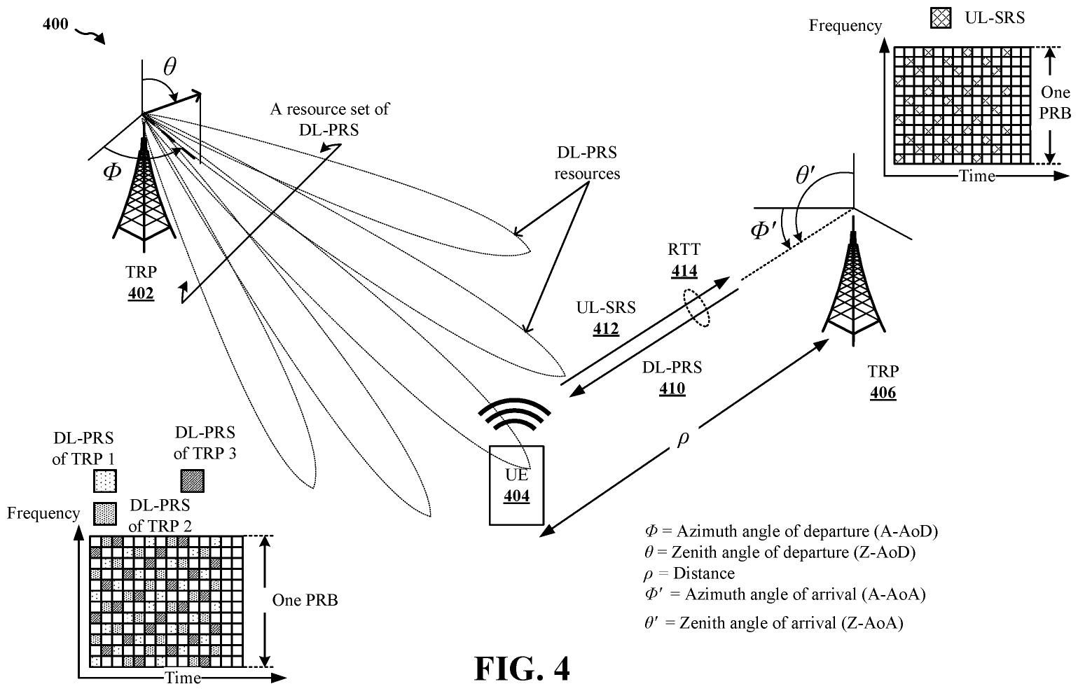

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ||T_{SRS_RX}−T_{PRS_TX}||T_{SRS_TX}−T_{PRS_RX}||. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning. PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In addition to network-based UE positioning technologies, a wireless device (e.g., a base station, a component of the base station, a UE, etc.) may also be configured to include radar capabilities, which may be referred to as “sensing,” “radio frequency (RF) sensing” and/or “cellular-based RF sensing.” For example, a wireless device may transmit radar reference signals (RRSs) and measure the RRSs reflected from one or more objects. Based at least in part on the measurement, the wireless device may determine or estimate a distance between the wireless device and the one or more objects. In another example, a first wireless device may also receive RRSs transmitted from a second wireless device, where the signal transmitted from the second wireless device may be reflected by another object before reaching the first wireless device. Then, the first wireless device may determine or estimate a distance between the first wireless device and the object based at least in part on the received RRS. In some examples, RF sensing techniques may be used for UE positioning and/or for assisting UE positioning. For purposes of the present disclosure, a device that is capable of performing RF sensing (e.g., transmitting and/or receiving RRS for detecting an object or for estimating the distance between the device and the object) may be referred to as an “RF sensing node.” For example, an RF sensing node may be a UE, a base station, a component of the base station, a TRP, a device capable of transmitting RRS, and/or a device configured to perform radar functions, etc.

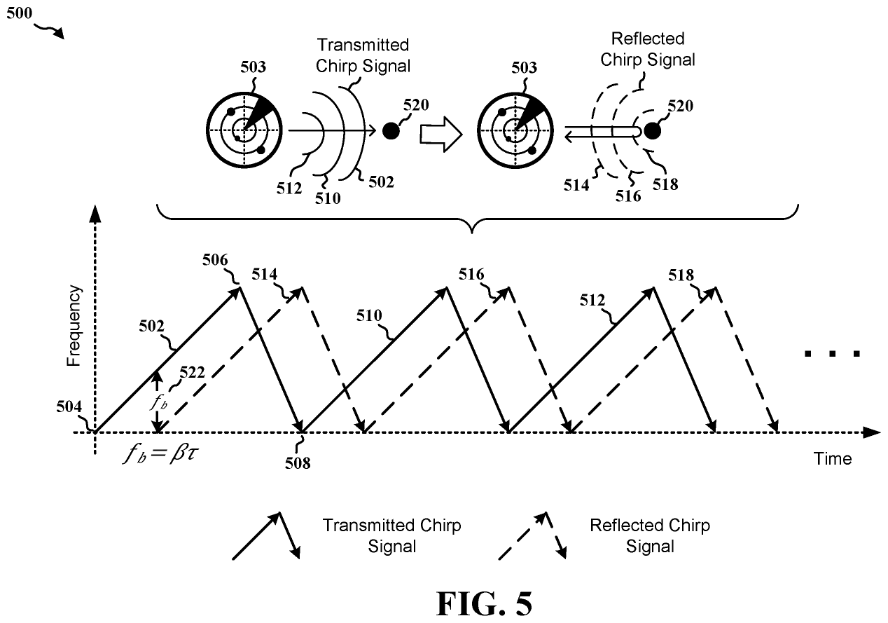

FIG. 5 is a diagram 500 illustrating an example radar signal (e.g., RRS) generated from an RF sensing node in accordance with various aspects of the present disclosure. An RF sensing node 503 may detect an object 520 (e.g., the location, the distance, and/or the speed of the object 520 with respect to the RF sensing node 503) by transmitting RRS towards the object 520 and receiving the RRS reflected (e.g., bounce off) from the object 520. In some examples, the object 520 may be a radar receiver or have a capability to receive and process RRS.

In one example, the RRS may be a chirp signal that includes a frequency that varies linearly (e.g., has a frequency sweeping) over a fixed period of time (e.g., over a sweep time) by a modulating signal. For example, as shown by the diagram 500, a transmitted chirp signal 502 may have a starting frequency at 504 of a sinusoid. Then, the frequency may gradually (e.g., linearly) increase on the sinusoid until it reaches an ending (or highest) frequency at 506 of the sinusoid, and then the frequency of the signal may return to the starting frequency as shown at 508 and another chirp signal 510 may be transmitted in the same way. In other words, each chirp signal may include an increase in frequency (e.g., linearly) and a drop in frequency or vice versa (e.g., including a decrease in frequency and then an increase in frequency), such that the RF sensing node 503 may transmit chirp signals sweeping in frequency. In some examples, such chirp signal may also be referred to as a frequency modulated continuous wave (FMCW), a sensing technique that is based on FMCW may be referred to as FMCW sensing, and a radar that is based on FMCW may be referred to a FMCW radar.

After a chirp signal (e.g., chirp signal 502, 510, 512, etc.) is transmitted by the RF sensing node 503, the transmitted chirp signal may reach the object 520 and reflect back to the RF sensing node 503, such as shown by the reflected chirp signals 514, 516, and 518, which may correspond to the transmitted chirp signals 502, 510, and 512, respectively. As there may be a distance between the RF sensing node 503 and the object 520 and/or it may take time for a transmitted chirp signal to reach the object 520 and reflect back to the RF sensing node 503, a delay may exist between a transmitted chirp signal and its corresponding reflected chirp signal. As the delay may be proportional to a range between the RF sensing node 503 and the object 520 (e.g., the further the target, the larger the delay and vice versa), the RF sensing node 503 may be able to measure or estimate a distance between the RF sensing node 503 and the object 520 based on the delay.

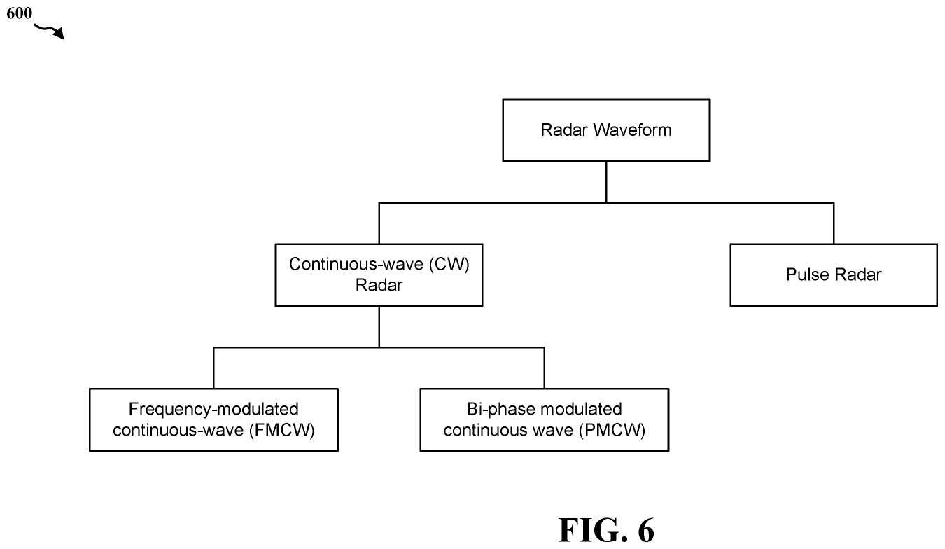

In some examples, the RF sensing node 503 may also measure a difference in frequency between the transmitted chirp signal and the reflected chirp signal, which may also be proportional to the distance between the RF sensing node 503 and the object 520. In other words, as the frequency difference between the reflected chirp signal and the transmitted chirp signal increases with the delay, and the delay is linearly proportional to the range, the distance of the object 520 from the RF sensing node 503 may also be determined based on the difference in frequency. Thus, the reflected chirp signal from the object 520 may be mixed with the transmitted chirp signal and down-converted to produce a beat signal (fb) which may be linearly proportional to the range after demodulation. For example, the RF sensing node 503 may determine a beat signal 522 by mixing the transmitted chirp signal 502 and its corresponding reflected chirp signal 514. While examples in the diagram illustrate using an FMCW waveform for the RRS, other types of radar waveforms may also be used by the RF sensing node 503 for the RRS. For example, as shown by a diagram 600 of FIG. 6, in some examples, a radar waveform may be categorized into continuous-wave (CW) radar waveform and pulse radar waveform, where the FMCW waveform and bi-phase modulated continuous wave (PMCW) may be part of the CW radar waveform.

Typically, radar systems may send probing signals (e.g., RRSs) to targets and infer useful information contained in the target echoes, and communication systems may enable information to be exchanged between two or more wireless devices. Due to an increased amount of bandwidth being allocated for cellular communications systems (e.g., 5G/6G and beyond) and an increased amount of applications (e.g., use cases) being introduced with cellular communications systems, joint communication and RF sensing, which may also be referred to as joint communication and sensing (JCS), integrated sensing and communication (ISAC), and/or joint communication-radar (JCR) (collectively as JCS hereafter), may become an important feature for cellular systems. JCS may refer to an integrated system that is capable of simultaneously performing both wireless communication and radar sensing, which may provide a cost-efficient deployment for both radar and communication systems. Time, frequency, and/or spatial radio resources may be allocated to support two purposes (communication and sensing) in the integrated system. For example, a wireless device (e.g., a base station, a component of a base station, a UE, a component of a UE, an RF sensing node, etc.) may be configured to transmit communication signals (e.g., PDSCH, PUSCH, PSSCH, etc.) with radar signals (e.g., RRS, FMCW signals, etc.) simultaneously or close in time (e.g., based on TDM, FDM, SDM, etc.), such as by diverting part of the radio resource from communications to support radar/RF sensing operations. In addition, an OFDM waveform (or its variants) may be used as the waveform for the JCS as the OFDM waveform may enable in-band multiplexing with other cellular reference signals and physical channels. As such, the radar signals may be multiplexed with communication signals based on OFDM waveform. For purposes of the present disclosure, a wireless device that performs an RF sensing based on OFDM waveform(s) or transmits RRS based on OFDM waveform(s) may be referred to as an “OFDM radar.” An OFDM waveform may refer to a waveform associated with a multi-carrier modulation system where data may be transmitted as a combination of orthogonal narrowband signals known as subcarriers. OFDM may be built upon a single carrier modulation such as QAM and may be transmitted at similar data rates.

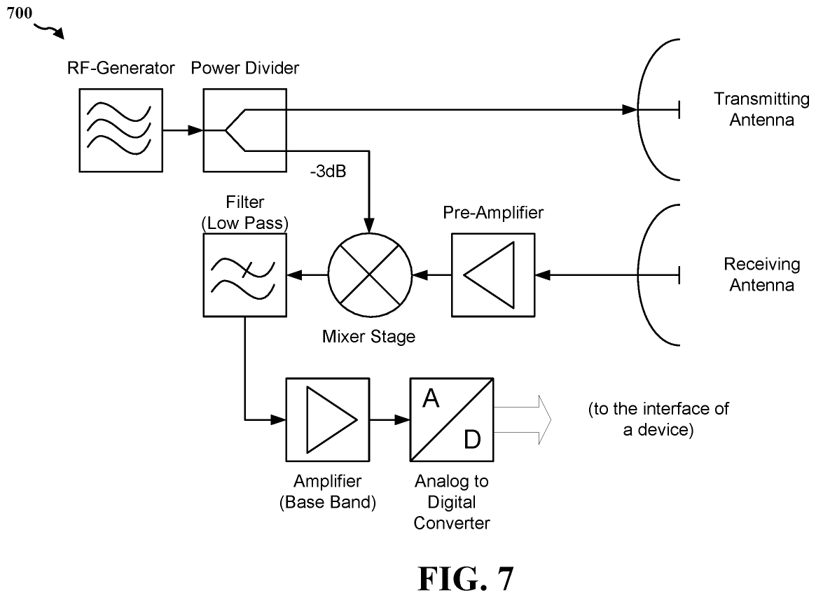

FIG. 7 is a diagram 700 illustrating an example architecture of a FMCW radar in accordance with various aspects of the present disclosure. In some examples, as a FMCW radar (or an RF sensing device based on FMCW waveform) may have a lower complexity in design/implementation and/or lower power consumption compared to other types of radar or radar waveforms, the OFDM waveform (for communication) and the FMCW waveform (for RF sensing) may be a suitable combination and candidates for a JCR and for waveform hybridization. For example, as shown by the diagram 700, a FMCW radar (or a CW radar) may specify just a low rate analog to digital converter (A/D), and at a minimum, the low pass filter may be configured to just cover the differential frequency between radar signal transmission (Tx) and reception (Rx). In addition, most of the operation associated with the FMCW radar are based on analog signal, which may have a lower complexity and power consumption compared to a radar with most operations based on digital signals. While a digital FMCW may be configured, the low rate A/D property may still hold.

OFDM and/or DFT-s-OFDM may be the main waveform(s) used for many wireless communications, as both of them may be viewed through a time-frequency grid, such as shown by FIGS. 2A to 2D. On the other hand, as discussed above, FMCW may also be modeled as a sloped-line (e.g., a chirp) in the time-frequency grid. In some scenarios, the sub-carriers in OFDM/DFT-s-OFDM may be orthogonal due to the fast Fourier transform (FFT) operations. However, orthogonality may be lost between sub-carriers in OFDM/DFT-s-OFDM and the FMCW signal (e.g., for a JCR). In addition, when a signal based on a FMCW waveform (which may be referred to as a “FMCW signal” hereafter) is transmitted simultaneously with another signal based on an OFDM/DFT-s-OFDM waveform (which may collectively be referred to as an “OFDM signal” hereafter), interference may occur between the two signals if they are transmitted close in time and/or frequency.

Aspects presented herein may enable a JCR (e.g., a joint FMCW radar and communication system) to transmit and/or receive a FMCW signal and an OFDM signal using the same time and frequency resources (e.g., the signals are transmitted/received simultaneously using a same frequency band by one or more entities). Aspects presented herein may enable the interference between a FMCW signal and an OFDM signal to be manageable by keeping a frequency buffer zone around the FMCW signal when two signals are transmitted using same time and frequency resources. Aspects presented herein may also provide parameters and scheduling mechanisms for the frequency buffer zone and hopping schemes associated with digital FMCW waveforms, such that a joint sensing and communication system with a relatively low complexity and power consumption is provided.

In some scenarios, interference may exist between two arbitrary frequencies. For example, if there are two distinct frequencies f₁ and f₂ in an OFDM/DFT-s-OFDM symbol duration Tₛ, each frequency may be represented by a unit energy signal:

$$\frac{1}{\sqrt{{T}_{s}}} exp ( j 2 π {f}_{1} t ) and \frac{1}{\sqrt{{T}_{s}}} exp ( j 2 π {f}_{2} t )$$

respectively. Then, their cross-correlation (c_{f}_{₁}_{,f}_{₂}) may be represented based on:

$${c}_{{f}_{1} , {f}_{2}} = \frac{1}{{T}_{s}} {\int }_{0}^{{T}_{s}} exp ( j 2 π {f}_{1} t ) exp ( - j 2 π {f}_{2} t ) dt ,$$

$$and \vert {c}_{{f}_{1} , {f}_{2}} \vert = \vert \frac{sin [ π ( {f}_{1} - {f}_{2} ) {T}_{s} ]}{π ( {f}_{1} - {f}_{2} ) {T}_{s}} \vert < \frac{1}{π \vert {f}_{1} - {f}_{2} \vert {T}_{s}} .$$

In one example, without losing generality, assuming tone f₁=0, then f₂Tₛ≈n₂, where n₂ is the nominal “sub-carrier index” 0<n2≤N_{FFT}. It is called nominal sub-carrier index because the interference between frequencies f₁ and f₂ is zero if f₂ Tₛ=n₂; when f₂Tₛ≈n₂ but f₂Tₛ itself is not an integer, the interference between two tones f₁ and f₂ may be bounded by

$$\frac{1}{π {n}_{2}} .$$

In a general case without assuming f₁=0, the interference between frequencies f₁ and f₂ is bounded by

$$\frac{1}{π \vert {n}_{1} - {n}_{2} \vert} ,$$

with n₁ and n₂ the nominal “sub-carrier indices”. As such, a gap of a fraction of a total bandwidth may be sufficient to maintain the interference between two tones at a low level. For example, if N_{FFT}˜10³, then |n₁−n₂|˜10¹ may provide ˜10 dB suppression.

Similarly, interference between a tone and a chirp may also be kept at a low level by maintaining a gap of a fraction of a total bandwidth. For example, for a tone f and a chirp in an OFDM/DFT-s-OFDM symbol duration Tₛ, without losing generality, assuming the chirp starts at time zero (0) and ends at time aTₛ, where a is the slope of frequency with respect to the time (unit sec⁻²), such as described in connection with FIG. 5. In one example, the tone f may be represented by a unit energy signal

$$\frac{1}{\sqrt{{T}_{s}}} exp ( j 2 π {f}_{1} t )$$

and the chirp may be represented by a unit energy signal

$$\frac{1}{\sqrt{{T}_{s}}} exp ( j 2 π {at}^{2} ) .$$

Their cross-correlation (c_{f}_{₁}_{,at}) may be represented based on:

$${c}_{{f}_{1} , at} = \frac{1}{{T}_{s}} {\int }_{0}^{{T}_{s}} exp ( j 2 π {at}^{2} ) exp ( - j 2 π f t ) dt = \frac{exp ( - \frac{π {f}^{2}}{2 a} )}{{T}_{s}} {\int }_{0}^{{T}_{s}} exp [ j 2 {π ( \sqrt{a} t - \frac{f}{2 \sqrt{a}} )}^{2} ] dt ,$$

$$and \vert {c}_{{f}_{1} , at} \vert < exp ( - \frac{π {f}^{2}}{2 a} ) .$$

$$If {aT}_{s} = \frac{{n}_{max}}{{T}_{s}} , f = \frac{n}{{T}_{s}} , then \vert {c}_{{f}_{1} , at} \vert < exp ( - \frac{π}{2} \frac{{n}^{2}}{{n}_{max}} ) .$$

Thus, when the chirp is slow compared to the OFDM/DFT-s-OFDM symbol duration Tₛ, a gap of a bandwidth much larger than the frequency span of the chirp may be sufficient to maintain the interference at a low level, and a slower chirp may be beneficial for frequency reuse.

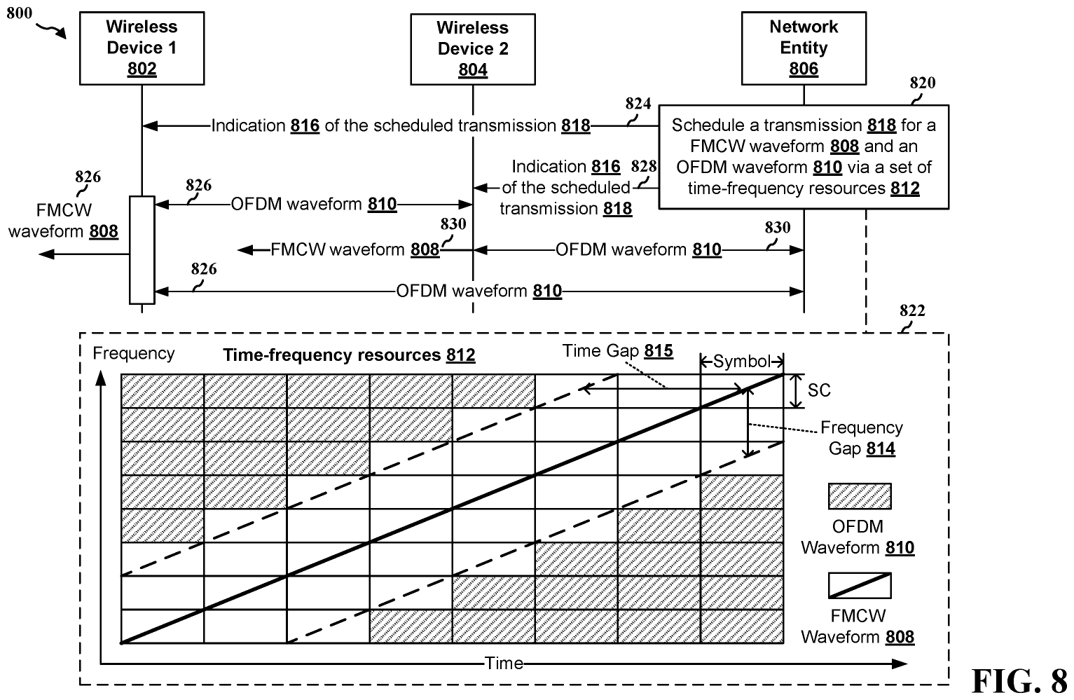

FIG. 8 is a communication flow 800 illustrating an example of configuring at least one wireless device to transmit/receive a FMCW signal and/or an OFDM signal via a same set of time and frequency resources based on a resource allocation that keeps a buffer zone between the FMCW signal and the OFDM signal to reduce interference between the two signals according to various aspects of the present disclosure. The numberings associated with the communication flow 800 do not specify a particular temporal order and are merely used as references for the communication flow 800. In one aspect, a frequency gap may be maintained between the FMCW waveform/frequency and subcarriers (SCs) scheduled for communications, where the frequency gap may be dependent on the residual interference level and interference tolerance. The FWCM waveform may be generated by an analog circuit without the step of converting the entire waveform from digital to analog, which may reduce the power consumption. But it may result in a lack of precise alignment of the FWCM waveform with the rest of OFDM system. In addition, separate transceivers may be used by the wireless devices (e.g., a UE, a base station, etc.). The FMCW waveform may be scheduled for a contiguous time to avoid phase discontinuity at any gap in time. Aspects presented herein may apply to both uplink and downlink scheduling.

At 820, a network entity 806 (e.g., a base station or a component of a base station) may schedule a transmission 818 that includes a FMCW waveform 808 and an OFDM waveform 810 via a set of time-frequency resources 812 (e.g., one or more resources in time domain and frequency domain in which one or more UEs may use for reception and/or for transmission). As shown at 822, the FMCW waveform 808 may be configured to be separated from the OFDM waveform 810 by a buffer zone, such as a frequency gap 814. In one example, the bandwidth of the frequency gap 814 may depend on the interference level between the FMCW waveform 808 and the OFDM waveform 810. For example, if the inference level is high, the network entity 806 may configure a larger frequency gap 814, whereas if the inference level is low, the network entity 806 may configure a smaller frequency gap 814, etc. As such, the frequency gap 814 is maintained between the FMCW waveform 808 and the OFDM waveform 810 (e.g., SCs scheduled for communications).

In one aspect, the network entity 806 may schedule or configure the transmission 818 for one wireless device, such that the wireless device may transmit or receive the OFDM waveform 810 and/or the FMCW waveform 808 via the set of time-frequency resources 812. For example, at 824, the network entity 806 may transmit an indication 816 indicating the scheduled transmission 818 to a first wireless device 802 (e.g., a UE, a base station, etc.). The network entity 806 may transmit the indication 816 periodically or semi-persistently. Then, at 826, the first wireless device 802 may transmit/receive the OFDM waveform 810 and/or transmit the FMCW waveform 808 via the set of time-frequency resources 812.

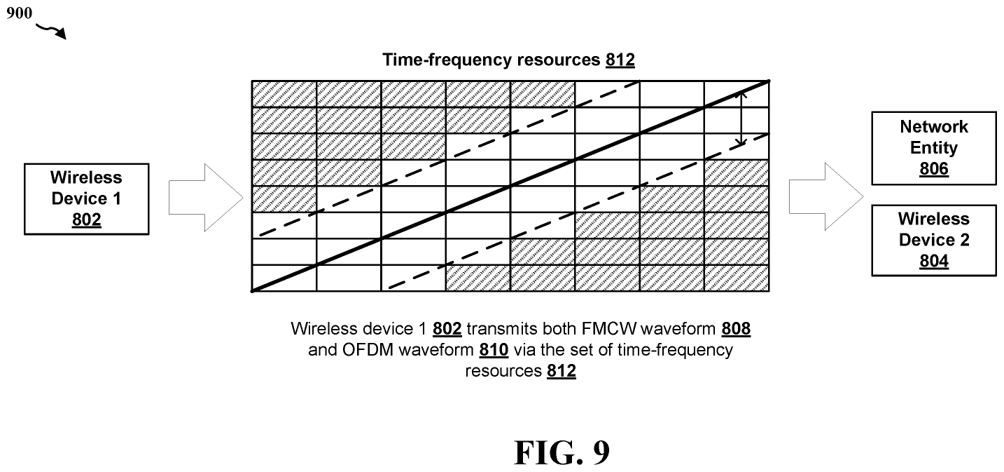

In one example, as shown by a diagram 900 of FIG. 9, based on the scheduled transmission 818, the first wireless device 802 may transmit both the FMCW waveform 808 and the OFDM waveform 810 (e.g., simultaneously), where the OFDM waveform 810 (e.g., the communication) may be transmitted to the network entity 806 or to a second wireless device 804. Then, the first wireless device 802 may monitor for the reflected FMCW waveform 808 to perform RF sensing, such as described in connection with FIG. 5.

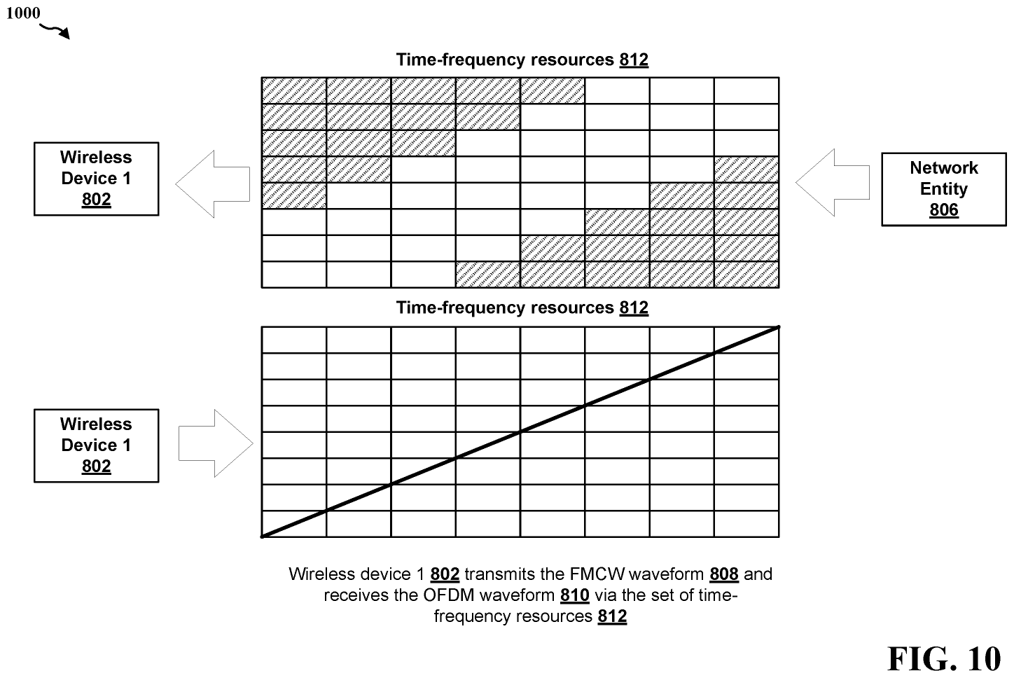

In another example, as shown by a diagram 1000 of FIG. 10, based on the scheduled transmission 818, the first wireless device 802 may transmit the FMCW waveform 808 and receive the OFDM waveform 810 (e.g., simultaneously) via the set of time-frequency resources 812, such as from the network entity 806. Similarly, the first wireless device 802 may monitor for the reflected FMCW waveform 808 to perform RF sensing.

In another aspect, the network entity 806 may schedule or configure the transmission 818 for multiple wireless devices, such that the OFDM waveform 810 and the FMCW waveform 808 may be transmitted/received by different wireless devices via the set of time-frequency resources 812. For example, referring back to FIG. 8, at 828, the network entity 806 may also transmit the indication 816 of the scheduled transmission 818 to a second wireless device 804. Then, at 830, the second wireless device 804 may also transmit at least one of the FMCW waveform 808 or the OFDM waveform 810, and/or receive the OFDM waveform 810 via the set of time-frequency resources 812.

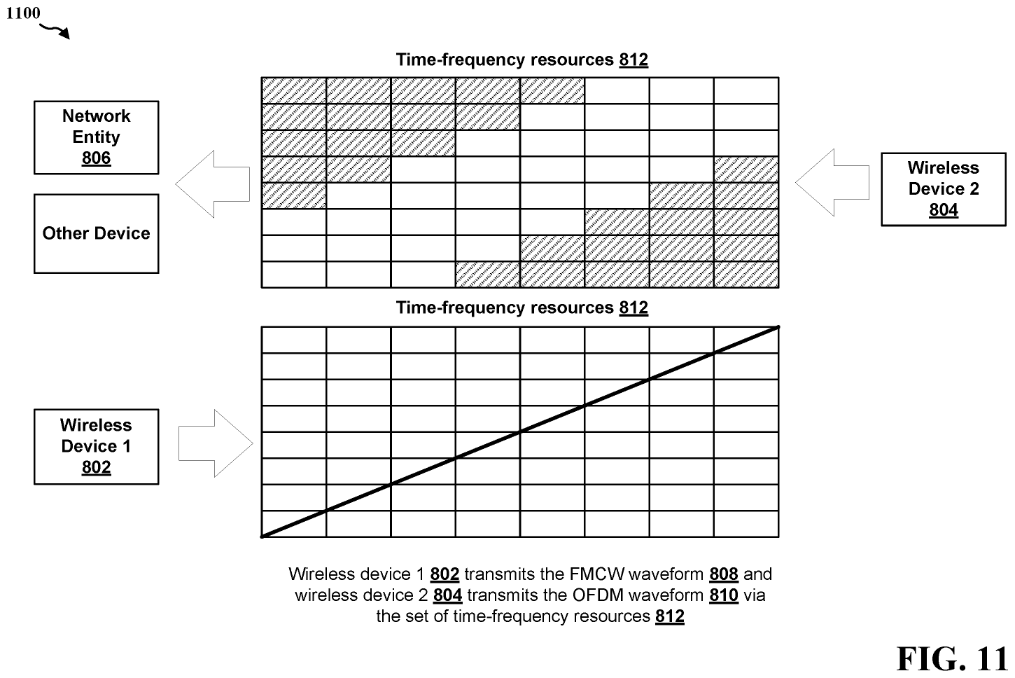

For example, as shown by a diagram 1100 of FIG. 11, based on the scheduled transmission 818, the first wireless device 802 may transmit the FMCW waveform 808 and the second wireless device 804 may transmit the OFDM waveform 810 (e.g., simultaneously) via the set of time-frequency resources 812 (e.g., to the network entity 806, the first wireless device 802, or another wireless device). Similarly, the first wireless device 802 may monitor for the reflected FMCW waveform 808 to perform RF sensing.

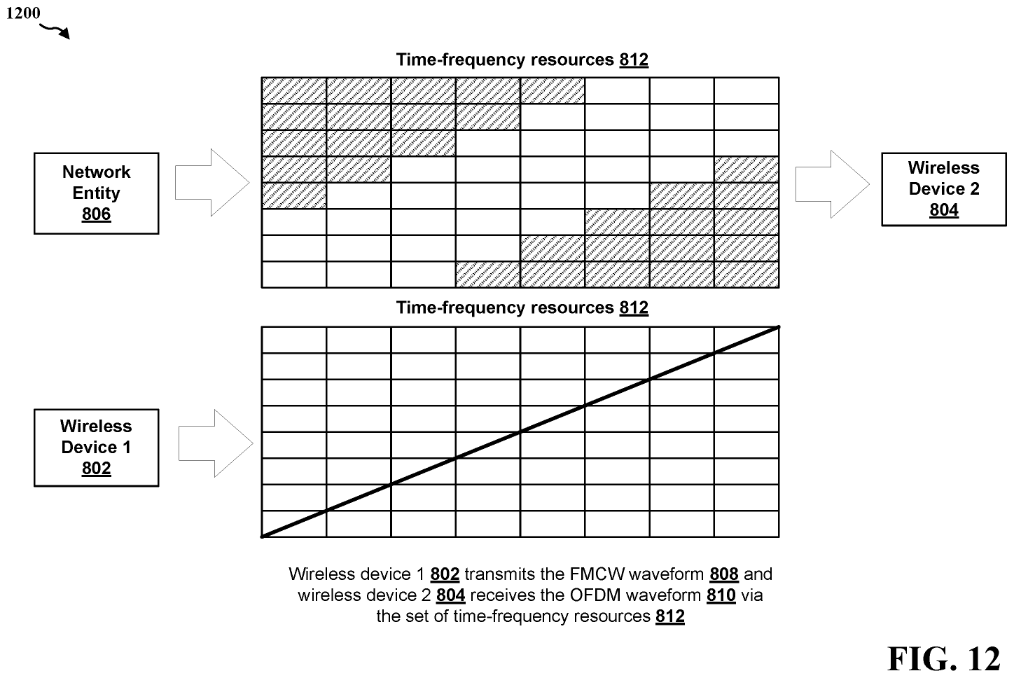

In another example, as shown by a diagram 1200 of FIG. 12, based on the scheduled transmission 818, the first wireless device 802 may transmit the FMCW waveform 808 and the second wireless device 804 may receive the OFDM waveform 810 (e.g., simultaneously) via the set of time-frequency resources 812 (e.g., from the network entity 806). Similarly, the first wireless device 802 may monitor for the reflected FMCW waveform 808 to perform RF sensing.

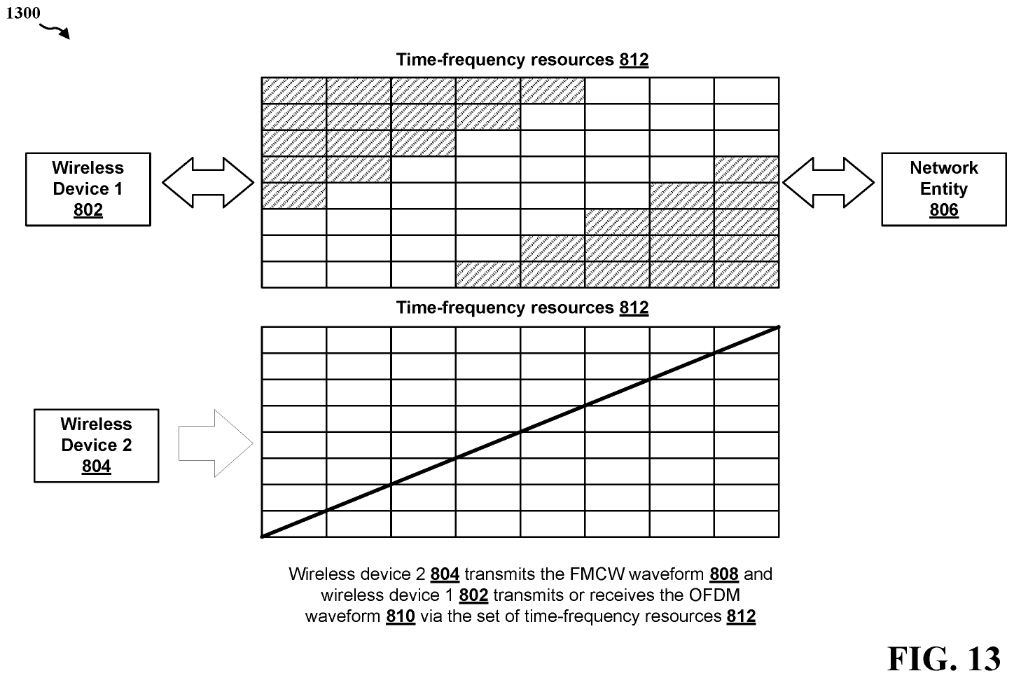

In another example, as shown by a diagram 1300 of FIG. 13, based on the scheduled transmission 818, the second wireless device 804 may transmit the FMCW waveform 808 and the first wireless device 802 may transmit or receive the OFDM waveform 810 (e.g., simultaneously) via the set of time-frequency resources 812 (e.g., to or from the network entity 806). The second wireless device 804 may monitor for the reflected FMCW waveform 808 to perform RF sensing, such as described in connection with FIG. 5. Thus, as shown by FIGS. 9 to 13, the FMCW waveform 808 and/or the OFDM waveform 810 may be transmitted/received via the set of time-frequency resources 812 by different entities.

In another aspect, referring back to FIG. 8, in some examples, the buffer zone may further include a time gap 815, where the time gap 815 may separate the FMCW waveform 808 and the OFDM waveform 810 around the same frequency or frequency band by a duration (e.g., one symbol, two symbols, etc.). The duration of the time gap 815 may also depend on the interference level between the FMCW waveform 808 and the OFDM waveform 810. For example, if the inference level is high, the network entity 806 may configure a larger time gap 815, whereas if the inference level is low, the network entity 806 may configure a smaller time gap 815, etc.

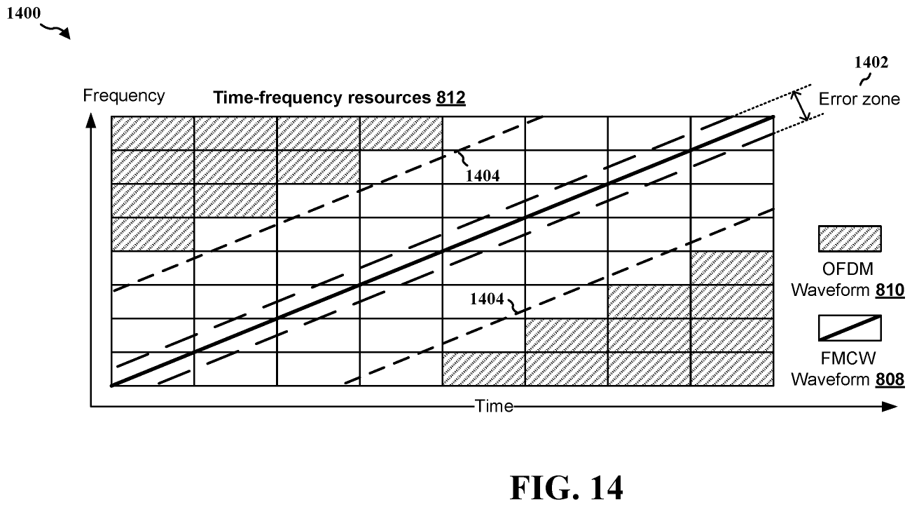

In some scenarios, as shown by a diagram 1400 of FIG. 14, as the FMCW waveform 808 may be generated by analog circuits, the time and frequency errors of the analog FMCW waveform 808 may be larger than the OFDM waveform 810, such as shown at 1402. Thus, as shown at 1404, extra margins in frequency and time may be configured between the FMCW waveform 808 and the OFDM waveform 810 (e.g., between the time-frequency range of FMCW and resources scheduled for communications). In some examples, the magnitude of errors may be exchanged/configured for the first wireless device 802 and/or the second wireless device during set up through radio resource control (RRC) signaling. In another example, the error range may also be pre-defined for different classes of devices, such that each class may have a predefined error range. For example, a device in a higher class (e.g., a UE with a higher UE capability, better radar hardware/performance, etc.) may be associated with a smaller error range compared to a device in a lower class (e.g., a UE with a lower UE capability, less sophisticate radar hardware, etc.). As such, the FMCW waveform 808 may be associated with an error range, and the frequency gap 814 and/or the time gap 815 may be adjusted based on the error range.

In another aspect of the present disclosure, as a FMCW radar measures the difference in frequency of the received signal and transmitted signal, the bandwidth of the frequency gap 814 may be based on the transmission range of the FMCW waveform 808. For example, the measured frequency difference by a FMCW radar may be 2aτ with t as the one-way propagation delay and a as the slope of the FMCW waveform 808 (e.g., as discussed in connection with FIG. 5). Given a maximum range, τₘₐₓ, for an ascending chirp, the frequency range of 2aτₘₐₓ below the FMCW frequency may not be used for communications. Similarly, for a descending chirp, the frequency range of 2aτₘₐₓ above the FMCW frequency may not be used for communications. In addition, the frequency gap 814 may also be enlarged based on the maximum Doppler anticipated due to a target or a transmitter movement. In another example, the frequency gap 814 may also be configured to be larger than the bandwidth of the low pass filter for the FMCW radar receiver A/D, such as shown by FIG. 7. As such, the bandwidth for the frequency gap 814 may be determined based on the interference, ranging, and filter considerations (e.g., the largest value may be used).

In another example, the FMCW waveform 808 may be associated with a reserved resource indication. For example, referring back to FIG. 8, a set of UEs, which may include the first wireless device 802 and the second wireless device 804, may be notified by the network entity 806 regarding the resource scheduled for either downlink or uplink transmission (e.g., for transmitting OFDM waveform 810). Then, the resource curved out for transmitting the FMCW waveform 808 may be signaled/indicated as a “reserved resource.” This reserved resource may be signaled to the set of UEs by a separate control channel information element such that the shape of the resource allocated to a UE and to the reserved resource may be easier to signal. For example, if the carved out portion were used for the first wireless device 802, the resource for the first wireless device 802 may be a rectangle in the time-frequency grid. In another example, the reserved resource may also be represented by a start frequency and an end frequency (or a chirp slope) for a certain time period, and a wireless device (e.g., a UE and a network entity) may be configured to rate-match around the reserved resources. In another example, the FMCW waveform 808 may be configured not to occupy resources used for important communication functions, such as master information block (MIB), synchronization channel, etc. For example, these channels may be designed to avoid using the entire bandwidth at any given time.

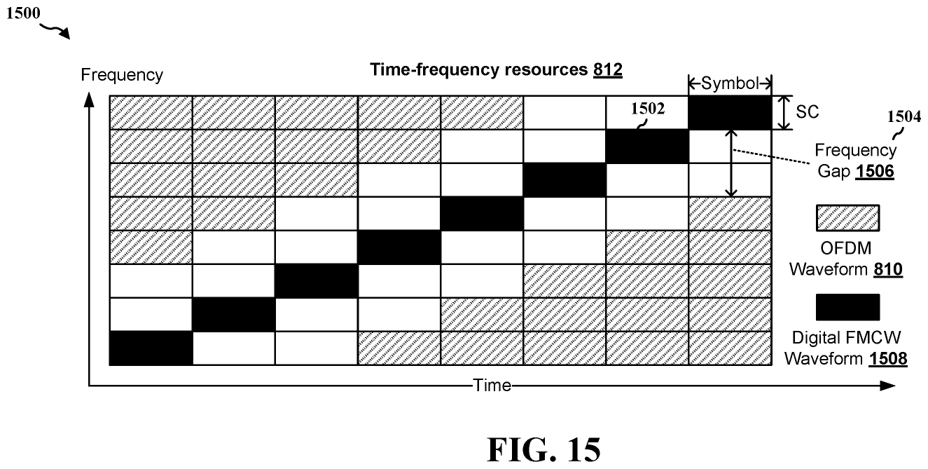

In another aspect of the present disclosure, a FMCW waveform may also be generated via one or more digital circuits. FIG. 15 is a diagram 1500 illustrating an example of a digital FMCW waveform in accordance with various aspects of the present disclosure. As shown at 1502, a set of time-frequency resources may be used for RF sensing (e.g., for transmitting a digital FMCW waveform 1508), where the set of time-frequency resources may be arranged with a hopping pattern.

Similarly, as shown at 1504, a frequency gap 1506 may still be provided/configured between the digital FMCW waveform 1508 and the OFDM waveform 810, such that a low rate analog to digital converter (A/D) may be used by a RF sensing receiver in a similar way as in analog FMCW. In one example, the frequency gap 1506 may be chosen to satisfy the ranging and analog to digital converter low pass filter constraint without concern of interference or timing/frequency errors because the orthogonality may be maintained. The scheduling for the digital FMCW waveform may be the same as the analog FMCW described in connection with FIGS. 8 to 13. One advantage of using digital FMCW waveform is the capability to add a sequence to the FMCW-like waveform to make each waveform distinguishable when multiple such signals may interfere with each other. However, this may add receiver searcher complexity. While it may also be feasible to add a sequence for the analog FMCW waveform, the time/frequency mapping for the FMCW waveform may be harder and less precise in some examples.

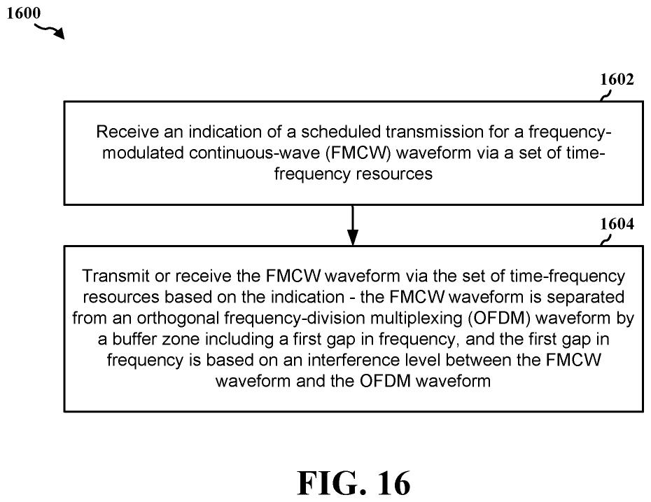

FIG. 16 is a flowchart 1600 of a method of wireless communication. In some scenarios, the method may be performed by a first wireless device (e.g., the UE 104, 404; the base station 102; the first wireless device 802; the second wireless device 804; the network entity 806; the apparatus 1704; the network entity 1802). The method may enable the first wireless device (e.g., a UE, a base station, a component of a base station, etc.) to transmit and/or receive an FMCW signal and an OFDM signal using the same time and frequency resources (e.g., the signals are transmitted/received simultaneously using a same frequency band by one or more entities).

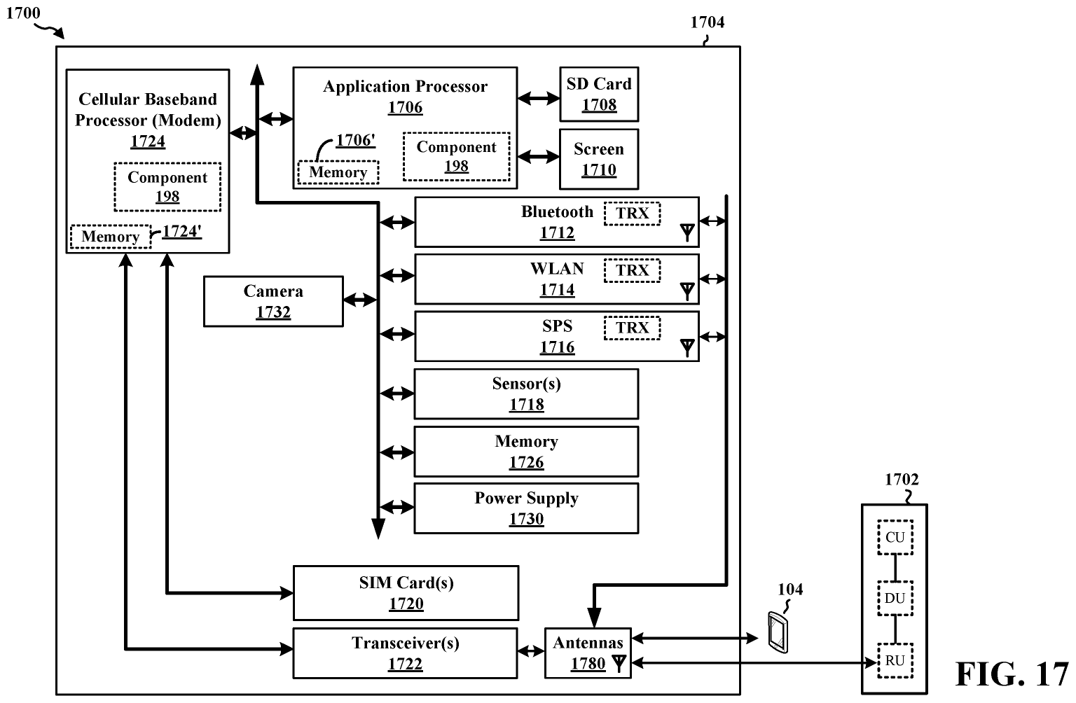

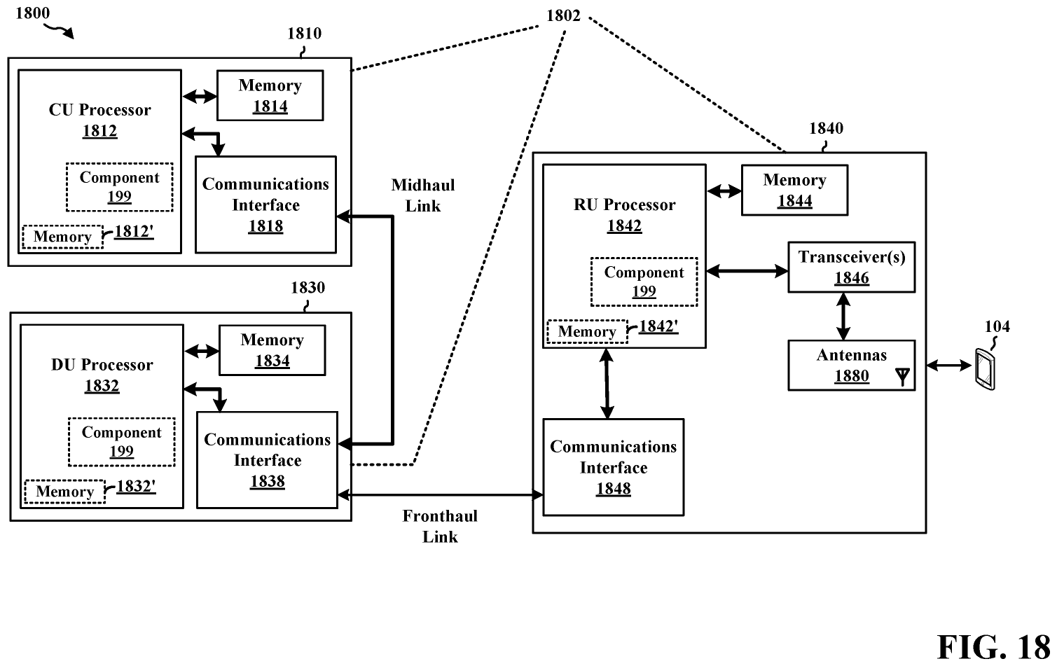

At 1602, the first wireless device may receive an indication of a scheduled transmission for an FMCW waveform via a set of time-frequency resources, such as described in connection with FIG. 8. For example, at 824, the first wireless device 802 may receive an indication 816 of a scheduled transmission 818 from the network entity 806. The reception of the indication may be performed by, e.g., the joint sensing and communication configuration component 198/199, the cellular baseband processor 1724 and/or the transceiver(s) 1722 of the apparatus 1704 in FIG. 17, or the transceiver(s) 1846 of the network entity 1802 in FIG. 18.

At 1604, the first wireless device may transmit or receive the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform, such as described in connection with FIGS. 8 to 15. For example, as shown at 822 of FIG. 8, the first wireless device 802 may transmit the FMCW waveform 808 via a set of time-frequency resources 812 based on the indication 816, where the FMCW waveform 808 is separated from an OFDM waveform 810 by a frequency gap 814. The transmission/reception of the FMCW waveform via the set of time-frequency resources may be performed by, e.g., the joint sensing and communication configuration component 198/199, the cellular baseband processor 1724 and/or the transceiver(s) 1722 of the apparatus 1704 in FIG. 17, or the transceiver(s) 1846 of the network entity 1802 in FIG. 18.

In one example, the first wireless device may transmit the OFDM waveform via the set of time-frequency resources after the indication of the scheduled transmission is received. In such an example, the FMCW waveform is transmitted or received via the set of time-frequency resources at a same time as the OFDM waveform is transmitted.

In another example, the first wireless device may receive the OFDM waveform via the set of time-frequency resources after the indication of the scheduled transmission is received. In such an example, the OFDM waveform is received from a network entity or a second wireless device.

In another example, the buffer zone further includes a second gap in time, where the second gap in time is based on the interference level between the FMCW waveform and the OFDM waveform. In such an example, the FMCW waveform is associated with an error range, and the first wireless device may adjust at least one of the first gap in frequency or the second gap in time based on the error range.

In another example, the indication of the scheduled transmission is received periodically or semi-persistently.

In another example, the FMCW waveform is transmitted to a second wireless device, or where the FMCW waveform is transmitted and received by the first wireless device.

In another example, the first gap in frequency is greater than 2aτₘₐₓ, where τₘₐₓ is a maximum one-way propagation delay and a is a slope of the FMCW waveform.

In another example, the first gap in frequency is larger than a first bandwidth of a low pass filter of the first wireless device, or where the first gap in frequency is larger than a second bandwidth of a second wireless device receiving the FMCW waveform.

In another example, the FMCW waveform is associated with a reserved resource indication.

In another example, the FMCW waveform is generated via one or more analog circuits and the OFDM waveform is generated via one or more digital circuits.

In another example, the FMCW waveform is generated via one or more digital circuits, and where the FMCW waveform is associated with a hopping pattern.

In another example, the interference level is further based on at least one of: one or more subcarriers for the OFDM waveform or a symbol duration of the OFDM waveform.

In another example, the first wireless device is a UE, and where the indication of the scheduled transmission is received from a network entity.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., sec 350 of FIG. 3) and include the additional modules of the apparatus 1704.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the joint sensing and communication configuration component 198, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the joint sensing and communication configuration component 198/199 is configured to receive an indication of a scheduled transmission for an FMCW waveform via a set of time-frequency resources. The joint sensing and communication configuration component 198/199 may also be configured to transmit or receive the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform. The joint sensing and communication configuration component 198 may be within the cellular baseband processor 1724, the application processor 1706, or both the cellular baseband processor 1724 and the application processor 1706. The joint sensing and communication configuration component 198/199 may be one or more hardware components specifically configured to carry out the stated processes/algorithm, implemented by one or more processors configured to perform the stated processes/algorithm, stored within a computer-readable medium for implementation by one or more processors, or some combination thereof. The Joint sensing and communication configuration component 199 may be within one or more processors of one or more of the CU 1810, DU 1830, and the RU 1840. The Joint sensing and communication configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions.

As shown, the apparatus 1704 or the network entity 1802 may include a variety of components configured for various functions. In one configuration, the network entity 1802 or the apparatus 1704 (in particular the cellular baseband processor 1724 and/or the application processor 1706), includes means for receiving an indication of a scheduled transmission for an FMCW waveform via a set of time-frequency resources. The apparatus 1704 or the network entity 1802 may further include means for transmitting or receiving the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform.

In one configuration, the apparatus 1704 or the network entity 1802 may further include means for transmitting the OFDM waveform via the set of time-frequency resources after the indication of the scheduled transmission is received. In such a configuration, the FMCW waveform is transmitted or received via the set of time-frequency resources at a same time as the OFDM waveform is transmitted.

In another configuration, the apparatus 1704 or the network entity 1802 may further include means for receiving the OFDM waveform via the set of time-frequency resources after the indication of the scheduled transmission is received. In such a configuration, the OFDM waveform is received from a network entity or a second wireless device.

In another configuration, the buffer zone further includes a second gap in time, where the second gap in time is based on the interference level between the FMCW waveform and the OFDM waveform. In such a configuration, the FMCW waveform is associated with an error range, and the apparatus 1704 or the network entity 1802 may further include means for adjusting at least one of the first gap in frequency or the second gap in time based on the error range.

In another configuration, the indication of the scheduled transmission is received periodically or semi-persistently.

In another configuration, the FMCW waveform is transmitted to a second wireless device, or where the FMCW waveform is transmitted and received by the first wireless device.

In another configuration, the first gap in frequency is greater than 2aτₘₐₓ, where τₘₐₓ is a maximum one-way propagation delay and a is a slope of the FMCW waveform.

In another configuration, the first gap in frequency is larger than a first bandwidth of a low pass filter of the first wireless device, or where the first gap in frequency is larger than a second bandwidth of a second wireless device receiving the FMCW waveform.

In another configuration, the FMCW waveform is associated with a reserved resource indication.

In another configuration, the FMCW waveform is generated via one or more analog circuits and the OFDM waveform is generated via one or more digital circuits.

In another configuration, the FMCW waveform is generated via one or more digital circuits, and where the FMCW waveform is associated with a hopping pattern.

In another configuration, the interference level is further based on at least one of: one or more subcarriers for the OFDM waveform or a symbol duration of the OFDM waveform.

In another configuration, the first wireless device is a UE, and where the indication of the scheduled transmission is received from a network entity.

In some examples, the means may be the joint sensing and communication configuration component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means. In other examples, the means may be the joint sensing and communication configuration component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

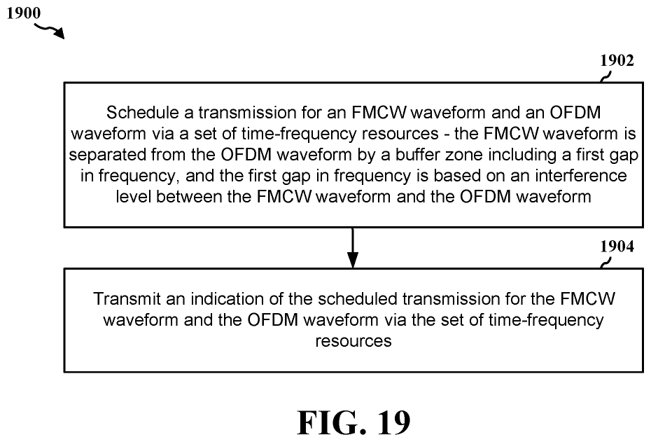

FIG. 19 is a flowchart 1900 of a method of wireless communication. In some scenarios, the method may be performed by a base station or a component of a base station (e.g., the base station 102; the network entity 806; the network entity 2002). The method may enable the base station to schedule one wireless device or a set of wireless devices to transmit/receive an FMCW signal and/or an OFDM signal using the same time and frequency resources.

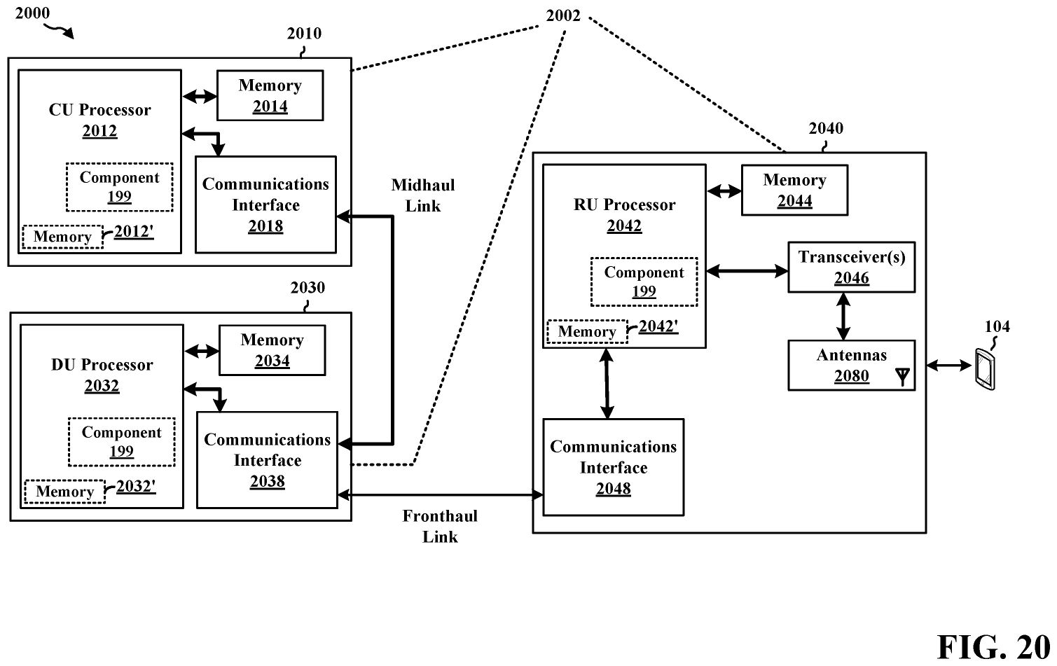

At 1902, the base station may schedule a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform, such as described in connection with FIGS. 8 to 15. For example, as shown at 820 of FIG. 8, the base station may schedule a transmission 818 for a FMCW waveform 808 and an OFDM waveform 810 via a set of time-frequency resources 812. The scheduling of the transmission for an FMCW waveform and an OFDM waveform may be performed by, e.g., the joint sensing and communication configuration component 199 and/or the transceiver(s) 2046 of the network entity 2002 in FIG. 20.

At 1904, the base station may transmit an indication of the scheduled transmission for the FMCW waveform and the OFDM waveform via the set of time-frequency resources, such as described in connection with FIG. 8. For example, at 824, the network entity 806 may transmit an indication 816 of a scheduled transmission 818 to the first wireless device 802. The transmission of the indication may be performed by, e.g., the joint sensing and communication configuration component 199 and/or the transceiver(s) 2046 of the network entity 2002 in FIG. 20.

In one example, the base station may transmit at least one of the FMCW waveform or the OFDM waveform via the set of time-frequency resources after the indication of the scheduled transmission is transmitted. In such an example, the FMCW waveform is transmitted via the set of time-frequency resources at a same time as the OFDM waveform is transmitted.

In another example, the base station may receive at least one of the FMCW waveform or the OFDM waveform via the set of time-frequency resources after the indication of the scheduled transmission is transmitted.

In another example, the buffer zone further includes a second gap in time, where the second gap in time is based on the interference level between the FMCW waveform and the OFDM waveform. In such an example, the FMCW waveform is associated with an error range, and the base station may adjust at least one of the first gap in frequency or the second gap in time based on the error range.

In another example, the indication of the scheduled transmission is transmitted periodically or semi-persistently.

In another example, the first gap in frequency is greater than 2aτₘₐₓ, where τₘₐₓ is a maximum one-way propagation delay and a is a slope of the FMCW waveform.

In another example, the first gap in frequency is larger than a bandwidth of a low pass filter of a second wireless device receiving the FMCW waveform.

In another example, the indication further indicates that the FMCW waveform is associated with a reserved resource, and where the indication is transmitted to one or more wireless devices.

In another example, the base station may transmit a second indication to one or more wireless devices indicating that the FMCW waveform is associated with a reserved resource.

In another example, the base station may refrain from scheduling the transmission via the set of time-frequency resources over a communication with a threshold level of priority, where the communication with the threshold level of priority includes at least one of: a MIB or a synchronization channel.

In another example, the FMCW waveform is generated via one or more analog circuits and the OFDM waveform is generated via one or more digital circuits.

In another example, the FMCW waveform is generated via one or more digital circuits, and the FMCW waveform is associated with a hopping pattern.

In another example, the interference level is further based on at least one of: one or more subcarriers for the OFDM waveform or a symbol duration of the OFDM waveform.

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the joint sensing and communication configuration component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′. 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the joint sensing and communication configuration component 199 is configured to schedule a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform. The joint sensing and communication configuration component 199 may also be configured to transmit an indication of the scheduled transmission for the FMCW waveform and the OFDM waveform via the set of time-frequency resources. The joint sensing and communication configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The Joint sensing and communication configuration component 199 may be within one or more processors of one or more of the CU 2010, DU 2030, and the RU 2040. The Joint sensing and communication configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 2002 includes means for scheduling a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform. The network entity 2002 may further include means for transmitting an indication of the scheduled transmission for the FMCW waveform and the OFDM waveform via the set of time-frequency resources.

In one configuration, the network entity 2002 may further include means for transmitting at least one of the FMCW waveform or the OFDM waveform via the set of time-frequency resources after the indication of the scheduled transmission is transmitted. In such a configuration, the FMCW waveform is transmitted via the set of time-frequency resources at a same time as the OFDM waveform is transmitted.

In another configuration, the network entity 2002 may further include means for receiving at least one of the FMCW waveform or the OFDM waveform via the set of time-frequency resources after the indication of the scheduled transmission is transmitted.

In another configuration, the buffer zone further includes a second gap in time, where the second gap in time is based on the interference level between the FMCW waveform and the OFDM waveform. In such a configuration, the FMCW waveform is associated with an error range, and the network entity 2002 may further include means for adjusting at least one of the first gap in frequency or the second gap in time based on the error range.

In another configuration, the indication of the scheduled transmission is transmitted periodically or semi-persistently.

In another configuration, the first gap in frequency is greater than 2aτₘₐₓ, where τₘₐₓ is a maximum one-way propagation delay and a is a slope of the FMCW waveform.

In another configuration, the first gap in frequency is larger than a bandwidth of a low pass filter of a second wireless device receiving the FMCW waveform.

In another configuration, the indication further indicates that the FMCW waveform is associated with a reserved resource, and where the indication is transmitted to one or more wireless devices.

In another configuration, the network entity 2002 may further include means for transmitting a second indication to one or more wireless devices indicating that the FMCW waveform is associated with a reserved resource.

In another configuration, the network entity 2002 may further include means for refraining from scheduling the transmission via the set of time-frequency resources over a communication with a threshold level of priority, where the communication with the threshold level of priority includes at least one of: a MIB or a synchronization channel.

In another configuration, the FMCW waveform is generated via one or more analog circuits and the OFDM waveform is generated via one or more digital circuits.

In another configuration, the FMCW waveform is generated via one or more digital circuits, and the FMCW waveform is associated with a hopping pattern.

In another configuration, the interference level is further based on at least one of: one or more subcarriers for the OFDM waveform or a symbol duration of the OFDM waveform.

The means may be the joint sensing and communication configuration component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first wireless device, including: receiving an indication of a scheduled transmission for an FMCW waveform via a set of time-frequency resources; and transmitting or receiving the FMCW waveform via the set of time-frequency resources based on the indication, where the FMCW waveform is separated from an OFDM waveform by a buffer zone including a first gap in frequency, where the first gap in frequency is based on an interference level between the FMCW waveform and the OFDM waveform.

Aspect 2 is the method of aspect 1, further including: transmitting the OFDM waveform via the set of time-frequency resources after the indication of the scheduled transmission is received.

Aspect 3 is the method of aspect 2, where the FMCW waveform is transmitted or received via the set of time-frequency resources at a same time as the OFDM waveform is transmitted.

Aspect 4 is the method of any of aspects 1 to 3, further including: receiving the OFDM waveform via the set of time-frequency resources after the indication of the scheduled transmission is received.

Aspect 5 is the method of aspect 4, where the OFDM waveform is received from a network entity or a second wireless device.

Aspect 6 is the method of any of aspects 1 to 5, where the buffer zone further includes a second gap in time, where the second gap in time is based on the interference level between the FMCW waveform and the OFDM waveform.

Aspect 7 is the method of aspect 6, where the FMCW waveform is associated with an error range, the method further including: adjusting at least one of the first gap in frequency or the second gap in time based on the error range.

Aspect 8 is the method of any of aspects 1 to 7, where the indication of the scheduled transmission is received periodically or semi-persistently.

Aspect 9 is the method of any of aspects 1 to 8, where the FMCW waveform is transmitted to a second wireless device, or where the FMCW waveform is transmitted and received by the first wireless device.

Aspect 10 is the method of any of aspects 1 to 9, where the first gap in frequency is greater than 2aτₘₐₓ, where τₘₐₓ is a maximum one-way propagation delay and a is a slope of the FMCW waveform.

Aspect 11 is the method of any of aspects 1 to 10, where the first gap in frequency is larger than a first bandwidth of a low pass filter of the first wireless device, or where the first gap in frequency is larger than a second bandwidth of a second wireless device receiving the FMCW waveform.

Aspect 12 is the method of any of aspects 1 to 11, where the FMCW waveform is associated with a reserved resource indication.

Aspect 13 is the method of any of aspects 1 to 12, where the FMCW waveform is generated via one or more analog circuits and the OFDM waveform is generated via one or more digital circuits.

Aspect 14 is the method of any of aspects 1 to 13, where the FMCW waveform is generated via one or more digital circuits, and where the FMCW waveform is associated with a hopping pattern.

Aspect 15 is the method of any of aspects 1 to 14, where the interference level is further based on at least one of: one or more subcarriers for the OFDM waveform or a symbol duration of the OFDM waveform.

Aspect 16 is the method of any of aspects 1 to 15, where the first wireless device is a UE, and where the indication of the scheduled transmission is received from a network entity.

Aspect 17 is an apparatus for wireless communication at a first wireless device, including: a memory; and at least one processor coupled to the memory and, based at least in part on information stored in the memory, the at least one processor is configured to implement any of aspects 1 to 16.

Aspect 18 is the apparatus of aspect 17, further including at least one of a transceiver or an antenna coupled to the at least one processor.

Aspect 19 is an apparatus for wireless communication including means for implementing any of aspects 1 to 16.

Aspect 20 is a computer-readable medium (e.g., a non-transitory computer-readable medium) storing computer executable code, where the code when executed by a processor causes the processor to implement any of aspects 1 to 16.

Aspect 21 is a method of wireless communication at a network entity, including: scheduling a transmission for an FMCW waveform and an OFDM waveform via a set of time-frequency resources, where the FMCW waveform is separated from the OFDM waveform by a buffer zone including a first gap in frequency, where the first gap in frequency is based on an interference level between the FMCW waveform and the OFDM waveform; and transmitting an indication of the scheduled transmission for the FMCW waveform and the OFDM waveform via the set of time-frequency resources.

Aspect 22 is the method of aspect 21, further including: transmitting at least one of the FMCW waveform or the OFDM waveform via the set of time-frequency resources after the indication of the scheduled transmission is transmitted.

Aspect 23 is the method of aspect 22, where the FMCW waveform is transmitted via the set of time-frequency resources at a same time as the OFDM waveform is transmitted.

Aspect 24 is the method of any of aspects 21 to 23, further including: receiving at least one of the FMCW waveform or the OFDM waveform via the set of time-frequency resources after the indication of the scheduled transmission is transmitted.

Aspect 25 is the method of any of aspects 21 to 24, where the buffer zone further includes a second gap in time, where the second gap in time is based on the interference level between the FMCW waveform and the OFDM waveform.

Aspect 26 is the method of aspect 25, where the FMCW waveform is associated with an error range, the method further including: adjusting at least one of the first gap in frequency or the second gap in time based on the error range.

Aspect 27 is the method of any of aspects 21 to 26, where the indication of the scheduled transmission is transmitted periodically or semi-persistently.

Aspect 28 is the method of any of aspects 21 to 27, where the first gap in frequency is greater than 2aτₘₐₓ, where τₘₐₓ is a maximum one-way propagation delay and a is a slope of the FMCW waveform.

Aspect 29 is the method of any of aspects 21 to 28, where the first gap in frequency is larger than a bandwidth of a low pass filter of a second wireless device receiving the FMCW waveform.

Aspect 30 is the method of any of aspects 21 to 29, where the indication further indicates that the FMCW waveform is associated with a reserved resource, and where the indication is transmitted to one or more wireless devices.

Aspect 31 is the method of any of aspects 21 to 30, further including: transmitting a second indication to one or more wireless devices indicating that the FMCW waveform is associated with a reserved resource.

Aspect 32 is the method of any of aspects 21 to 31, further including: refraining from scheduling the transmission via the set of time-frequency resources over a communication with a threshold level of priority, where the communication with the threshold level of priority includes at least one of: a master information block (MIB) or a synchronization channel.

Aspect 33 is the method of any of aspects 21 to 32, where the FMCW waveform is generated via one or more analog circuits and the OFDM waveform is generated via one or more digital circuits.

Aspect 34 is the method of any of aspects 21 to 33, where the FMCW waveform is generated via one or more digital circuits, and the FMCW waveform is associated with a hopping pattern.

Aspect 35 is the method of any of aspects 21 to 34, where the interference level is further based on at least one of: one or more subcarriers for the OFDM waveform or a symbol duration of the OFDM waveform.

Aspect 36 is an apparatus for wireless communication at a network entity, including: a memory; and at least one processor coupled to the memory and, based at least in part on information stored in the memory, the at least one processor is configured to implement any of aspects 21 to 35.

Aspect 37 is the apparatus of aspect 36, further including at least one of a transceiver or an antenna coupled to the at least one processor.

Aspect 38 is an apparatus for wireless communication including means for implementing any of aspects 21 to 35.

Aspect 39 is a computer-readable medium (e.g., a non-transitory computer-readable medium) storing computer executable code, where the code when executed by a processor causes the processor to implement any of aspects 21 to 35.

What is claimed is:

1. An apparatus for wireless communication at a first wireless device, comprising:
a memory; and
at least one processor coupled to the memory and, based at least in part on information stored in the memory, the at least one processor is configured to:
receive an indication of a scheduled transmission for a frequency-modulated continuous-wave (FMCW) waveform via a set of time-frequency resources; and
transmit or receive the FMCW waveform via the set of time-frequency resources based on the indication, wherein the FMCW waveform is separated from an orthogonal frequency-division multiplexing (OFDM) waveform by a buffer zone including a first gap in frequency, wherein the first gap in frequency is based on an interference level between the FMCW waveform and the OFDM waveform.

2. The apparatus of claim 1, wherein the at least one processor is configured to transmit or receive the FMCW waveform via the set of time-frequency resources at a same time as the at least one processor is configured to transmit the OFDM waveform.

3. The apparatus of claim 1, wherein the at least one processor is further configured to:
receive the OFDM waveform via the set of time-frequency resources after the at least one processor is configured to receive the indication of the scheduled transmission.

4. The apparatus of claim 3, wherein the at least one processor is configured to receive the OFDM waveform from a network entity or a second wireless device.

5. The apparatus of claim 1, wherein the buffer zone further includes a second gap in time, wherein the second gap in time is based on the interference level between the FMCW waveform and the OFDM waveform.

6. The apparatus of claim 5, wherein the FMCW waveform is associated with an error range, the at least one processor is configured to:
adjust at least one of the first gap in frequency or the second gap in time based on the error range.

7. The apparatus of claim 1, wherein the at least one processor is configured to receive the indication of the scheduled transmission periodically or semi-persistently.

8. The apparatus of claim 1, wherein the at least one processor is configured to transmit the FMCW waveform to a second wireless device, or wherein the at least one processor is configured to transmit or receive the FMCW waveform by the first wireless device.

9. The apparatus of claim 1, wherein the first gap in frequency is greater than 2aτₘₐₓ, wherein τₘₐₓ is a maximum one-way propagation delay and a is a slope of the FMCW waveform.

10. The apparatus of claim 1, wherein the first gap in frequency is larger than a first bandwidth of a low pass filter of the first wireless device, or wherein the first gap in frequency is larger than a second bandwidth of a second wireless device associated with a reception of the FMCW waveform.

11. The apparatus of claim 1, wherein the FMCW waveform is associated with a reserved resource indication.

12. The apparatus of claim 1, wherein the FMCW waveform is configured to be generated via one or more analog circuits and the OFDM waveform is configured to be generated via one or more digital circuits.

13. The apparatus of claim 1, wherein the FMCW waveform is configured to be generated via one or more digital circuits, and wherein the FMCW waveform is associated with a hopping pattern.

14. The apparatus of claim 1, wherein the interference level is further based on at least one of: one or more subcarriers for the OFDM waveform or a symbol duration of the OFDM waveform.

15. The apparatus of claim 1, wherein the first wireless device is a user equipment (UE), and wherein the at least one processor is configured to receive the indication of the scheduled transmission from a network entity.

16. A method of wireless communication at a first wireless device, comprising:
receiving an indication of a scheduled transmission for a frequency-modulated continuous-wave (FMCW) waveform via a set of time-frequency resources; and
transmitting or receiving the FMCW waveform via the set of time-frequency resources based on the indication, wherein the FMCW waveform is separated from an orthogonal frequency-division multiplexing (OFDM) waveform by a buffer zone including a first gap in frequency, wherein the first gap in frequency is based on an interference level between the FMCW waveform and the OFDM waveform.

17. An apparatus for wireless communication at a network entity, comprising:
a memory; and
at least one processor coupled to the memory and, based at least in part on information stored in the memory, the at least one processor is configured to:
schedule a transmission for a frequency-modulated continuous-wave (FMCW) waveform and an orthogonal frequency-division multiplexing (OFDM) waveform via a set of time-frequency resources, wherein the FMCW waveform is separated from the OFDM waveform by a buffer zone including a first gap in frequency, wherein the first gap in frequency is based on an interference level between the FMCW waveform and the OFDM waveform; and
transmit an indication of the scheduled transmission for the FMCW waveform and the OFDM waveform via the set of time-frequency resources.

18. The apparatus of claim 17, wherein the at least one processor is further configured to:
transmit at least one of the FMCW waveform or the OFDM waveform via the set of time-frequency resources after the at least one processor is configured to transmit the indication of the scheduled transmission, wherein the FMCW waveform is configured to be transmitted via the set of time-frequency resources at a same time as the OFDM waveform is configured to be transmitted.

19. The apparatus of claim 17, wherein the at least one processor is further configured to:
receive at least one of the FMCW waveform or the OFDM waveform via the set of time-frequency resources after the at least one processor is configured to transmit the indication of the scheduled transmission.

20. The apparatus of claim 17, wherein the buffer zone further includes a second gap in time, wherein the second gap in time is based on the interference level between the FMCW waveform and the OFDM waveform, wherein the FMCW waveform is associated with an error range.

21. The apparatus of claim 20, wherein the at least one processor is further configured to:
adjust at least one of the first gap in frequency or the second gap in time based on the error range.

22. The apparatus of claim 17, wherein the at least one processor is configured to transmit the indication of the scheduled transmission periodically or semi-persistently.

23. The apparatus of claim 17, wherein the first gap in frequency is greater than 2aτₘₐₓ, wherein τₘₐₓ is a maximum one-way propagation delay and a is a slope of the FMCW waveform.

24. The apparatus of claim 17, wherein the first gap in frequency is larger than a bandwidth of a low pass filter of a second wireless device associated with a reception of the FMCW waveform.

25. The apparatus of claim 17, wherein the indication further indicates that the FMCW waveform is associated with a reserved resource, and wherein the at least one processor is configured to transmit the indication to one or more wireless devices.

26. The apparatus of claim 17, wherein the at least one processor is further configured to:
transmit a second indication to one or more wireless devices indicating that the FMCW waveform is associated with a reserved resource.

27. The apparatus of claim 17, wherein the at least one processor is further configured to:
refrain from scheduling the transmission via the set of time-frequency resources over a communication with a threshold level of priority, wherein the communication with the threshold level of priority includes at least one of: a master information block (MIB) or a synchronization channel.

28. The apparatus of claim 17, wherein the FMCW waveform is configured to be generated via one or more digital circuits, and the FMCW waveform is associated with a hopping pattern.

29. The apparatus of claim 17, wherein the interference level is further based on at least one of: one or more subcarriers for the OFDM waveform or a symbol duration of the OFDM waveform.

30. A method of wireless communication at a network entity, comprising:
scheduling a transmission for a frequency-modulated continuous-wave (FMCW) waveform and an orthogonal frequency-division multiplexing (OFDM) waveform via a set of time-frequency resources, wherein the FMCW waveform is separated from the OFDM waveform by a buffer zone including a first gap in frequency, wherein the first gap in frequency is based on an interference level between the FMCW waveform and the OFDM waveform; and
transmitting an indication of the scheduled transmission for the FMCW waveform and the OFDM waveform via the set of time-frequency resources.
